(19) United States
(12) Patent Application Publication
(10) Pub. No.: US 2006/0207059 A1
(43) Pub. Date: Sep. 21, 2006

(54) Door retaining rod for a doorstop

(76) Inventor: Cristiaan Stefanus Lambertus Petrus Van Den Heuvel, Penetanguishene (CA)

Correspondence Address: Michael R. Friscia;McCarter & English, LLP, Four Gateway Center, 100 Mulberry Street, Newark, NJ, 07102, US

(21) Appl. No.: 11/141,683

(22) Filed: May 31, 2005

(30) Foreign Application Priority Data
Mar. 18, 2005 (CA) 2,501,197

(51) Int. Cl. E05F 5/02

(52) U.S. Cl. 16/86 B

(57) ABSTRACT

A door retaining rod for a doorstop utilising, for example, an arm of long strand type material, a metal plastic material or a formed wire encapsulated in a moulded arm.

### RELATED APPLICATIONS

This application claims the benefit of Canadian Patent Application No. 2,501,197 filed Mar. 18, 2005, the entire disclosure of which is expressly incorporated herein by reference.

### BACKGROUND OF THE INVENTION

### Field of the Invention

This invention relates to a door-retaining rod for a doorstop.

Doorstops are used particularly in motor vehicles. A doorstop is described in U.S. Pat. No. 6,842,943 issued Jan. 18, 2005 (Hoffman et al.)

### SUMMARY OF THE INVENTION

It is an object of the invention to provide a door-retaining rod which can be used in a doorstop and offer substantial advantages in cost of construction.

Accordingly from one aspect there is provided a door-retaining rod comprising a non-metallic moulded arm of long strand type material.

From another aspect there is provided a doorstop comprising a retainer piece disposed on one of a door and a door support and including a plastic housing with a main opening and a guide opening arranged perpendicular to the main opening and parallel to a pivot axis of the door; a door retaining rod comprising a non-metallic moulded arm articulated on the other of the door and the door support, the door retaining rod passing through the main opening of the retainer piece housing and including a brake ramp and a catch depression on a side of the door retaining rod; and a catch device configured to determine specific door opening positions and including a brake body and a spring, the catch device connecting the retainer piece and the door retaining rod to each other in a moveable manner, wherein the brake body includes a hollow cylinder having a semi-spherical closed end and an open end and is slidingly disposed in the guide opening of the retainer piece, the open end partially accommodating the spring therein so that the closed end is pre-tensioned by the spring relative to the brake ramp and catch depression and is guided in the guide opening free of tilt.

### DESCRIPTION OF THE DRAWINGS

Embodiments of the invention will now be described, by way of example, with reference to the accompanying drawings in which:

FIG. 1 shows a doorstop from U.S. Pat. No. 6,842,943 in a sectional side view;

FIG. 2 shows a door retaining rod in plan view constructed according to one embodiment of the invention;

FIG. 3 shows a door retaining rod in plan view according to another embodiment of the invention;

FIG. 4 shows the door-retaining rod of FIG. 3 in side view;

FIG. 5 shows a further embodiment of the invention in plan view;

FIG. 6 shows a yet further embodiment of the invention in plan view; and

FIG. 7 is a plan view of an insert used in the door-retaining rod of FIG. 6.

### DETAILED DESCRIPTION

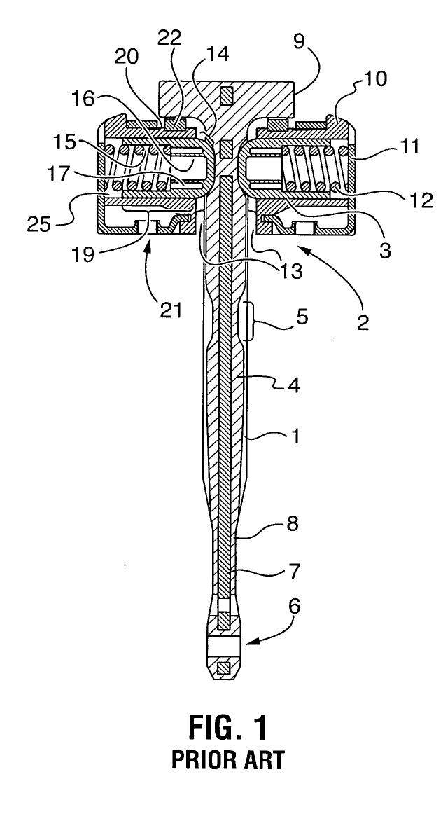

FIG. 1 shows a sectional side view of a doorstop, as illustrated in U.S. Pat. No. 6,842,943, the plane of section running through the doorstop parallel to the pivot axis and the door retaining rod 1 passing though the retaining piece 2. At its bottom end in the figure, the door-retaining rod 1 has a bearing eye 6 and at the other end an abutment 9. The door-retaining rod 1 is constructed from a metal core 7, for example a flat steel section, which is covered with plastic. The plastic covering 8 is applied with different thicknesses over the length and forms bulges in the form of local thickenings, which form the brake ramps 4 and the catch depressions 5 between the bulges. In the exemplary embodiment shown, the abutment 9, which forms the limit stop corresponding to the open position of the door, is of integral T-shaped design. The abutment 9 or the limit stop may also be alternatively formed by a pin, which is arranged through a corresponding opening in the door retaining rod 1 in the direction of the pivot axis. The brake ramps 4 and the catch depressions 5 are formed on the sides of the door-retaining rod facing the pivot axis. In the position shown the brake and/or stop bodies 3 bear bilaterally preloaded against catch depressions. The door-retaining rod 1 is led through the opening 13 in the housing 10. The brake and/or stop bodies 3 are guided in guide openings 25 arranged perpendicular to the opening 13.

The brake and/or stop bodies 3 take the form of hollow cylinders, which are sealed at one end by a semi-spherical cap 14. In their open end they accommodate a pressure spring 12 resting on the closing cap 14, the spring being supported on a side wall of the housing 10. The end faces of the housing 10 are enclosed by U-shaped metal frames 11, which also constitute the supporting wall for the pressure springs. The brake and/or stop bodies 3 have a central bore 16 accessible from their cylindrical cavity 15 and further bores 17 arranged in a circle around this. The shape and arrangement of the bores 16 and 17 permit approximately equal wall thicknesses in the semi-spherical cap 14. The semi-spherical cap 14 is truncated at its front end. The approximately equal wall thicknesses provide an advantageous prerequisite for manufacturing the brake and/or stop bodies from plastic by the injection molding process. In its cylindrical part 19 the outer wall of the brake and/or stop bodies 3 is fluted in the direction of movement, thereby on the one hand ensuring a favorable distribution and transmission of slide lubricants and on the other reducing the bearing surface of the cylindrical part 19 on the inner surface of the guide opening 25 and hence frictional forces occurring when the brake and/or stop bodies 3 slide in the guide opening 25.

Cushions 22 of an elastic material are integrated into the upper end surface 20 of the housing 10, against which cushions the abutment 9 resiliently strikes when the door is in the open position. Fixing apertures 21 are arranged in the bottom end surfaces of the metal frames 11. In the exemplary embodiment shown these have an internal thread for fixing the retainer piece to a door assembly piece by means of threaded screws. Press-on screws, not shown here, can also be used for fixing, however. It will be obvious that in the embodiment of the housing 10 and metal frame 11 shown there is a high degree of flexibility in the choice of hole spacing and hence in the hole piercing variants.

The present invention is particularly concerned with a door-retaining rod which offers advantages over that shown in the above-identified U.S. patent.

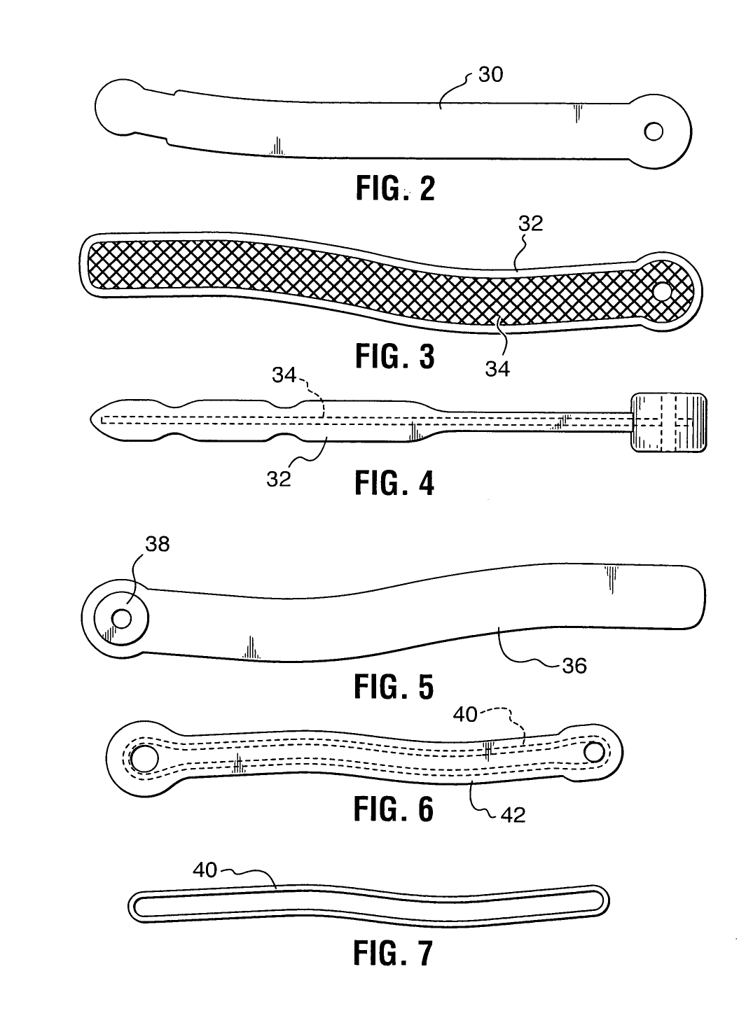

The door-retaining rod of FIG. 2 comprises a moulded arm 30 without an insert support and moulded with long strand type material or plastic filled material for strength and wearability.

In FIG. 3 a door retaining rod 32 includes a serrated wire frame 34 at least 0.1 mm thick as required for encapsulation in a “link” arm system as shown in FIG. 4 in cross-section.

FIG. 5 illustrates, in plan view, a “link” arm 36 to provide a door retaining rod with a solid metal bushing 38 encapsulated in the “link” arm using long strand or metal/plastic filled material for strength. The busing may be at one end or at both ends.

In FIG. 6 a formed wire 40 is encapsulated in a moulded-oven “link” arm 42, and FIG. 7 diagrammatically illustrates the “formed” wire 40 of FIG. 6 which is at least 0.1 mm thick as required and can be of flat or round cross-section dependent on its application. The wire 40 can, of course, be shaped to comply with whatever configuration is required.

Previous construction of a door-retaining rod normally utilises a solid piece of metal alone or as a metal core covered in plastic. By using the embodiments of the invention described herein it is anticipated that substantial cost savings will occur, possibly 30% or more. There will also be a substantial saving in weight.

It will be understood that injection moulding may be utilised and the parts may be run on vertical or horizontal machines. It is anticipated that multi-cavity molds may be used. Shrink and warp behaviour in insert moulding due to the size of the product is expected. Control of the process characteristics, such as mold temperatures, injection speeds and pressure is required. Proper drying of the material is required. Co-injection and/or over moulding can also be used to manufacture the product.

It will be also understood that, the fabrication technology used may be suitable for the formation of large, long-fibre-reinforced structural thermoplastic parts.

Having thus described the invention in detail, it is to be understood that the foregoing description is not intended to limit the spirit and scope thereof. What is desired to be protected by Letters Patent is set forth in the appended claims.

What is claimed is:

1. A door-retaining rod comprising a non-metallic molded arm of long strand type material.

2. The door-retaining rod of claim 1, further comprising a solid metal bushing encapsulated in an end of the door-retaining rod.

3. The door-retaining rod of claim 2, further comprising another solid metal bushing encapsulated in an opposite end of the door-retaining rod.

4. A door-retaining rod comprising a molded arm constructed of at least two different grades of plastic material.

5. The door-retaining rod of claim 4, further comprising a solid metal bushing encapsulated in an end of the door-retaining rod.

6. The door-retaining rod of claim 5, further comprising another solid metal bushing encapsulated in an opposite end of the door-retaining rod.

7. A door-retaining rod comprising a serrated wire frame encapsulated in a link arm system.

8. A door-retaining rod comprising a formed wire encapsulated in a molded link arm.

9. A doorstop comprising:
a retainer piece disposed on one of a door and a door support and including a plastic housing with a main opening and a guide opening arranged perpendicular to the main opening and parallel to a pivot axis of the door;
a door retaining rod comprising a non-metallic molded arm of long strand type material, wherein the door retaining rod is articulated on the other end of the door and the door support, the door retaining rod passing through the main opening of the retainer piece housing and including a brake ramp and a catch depression on a side of the door retaining rod; and
a catch device configured to determine specific door opening positions and including a brake body and a spring, the catch device connecting the retainer piece and the door retaining rod to each other and in a moveable manner, wherein the brake body includes a hollow cylinder having a semi-spherical closed end and an open end and is slidingly disposed in the guide opening of the retainer piece, the open end partially accommodating the spring therein so that the closed end is pre-tensioned by the spring relative to the brake ramp and catch depression and is guided in the guide opening free of tilt.

10. The door-retaining rod of claim 9, wherein the door retaining rod further comprises a solid metal bushing encapsulated in an end of said door-retaining rod.

11. The door-retaining rod of claim 10, wherein the door retaining rod further comprises another solid metal bushing encapsulated in an opposite end of said door-retaining rod.

12. A doorstop comprising:
a retainer piece disposed on one of a door and a door support and including a plastic housing with a main opening and a guide opening arranged perpendicular to the main opening and parallel to a pivot axis of the door;
a door retaining rod comprising a molded arm constructed of at least two different grades of plastic material, wherein the door retaining rod is articulated on the other end of the door and the door support, the door retaining rod passing through the main opening of the retainer piece housing and including a brake ramp and a catch depression on a side of the door retaining rod; and
a catch device configured to determine specific door opening positions and including a brake body and a spring, the catch device connecting the retainer piece and the door retaining rod to each other and in a moveable manner, wherein the brake body includes a hollow cylinder having a semi-spherical closed end and an open end and is slidingly disposed in the guide opening of the retainer piece, the open end partially accommodating the spring therein so that the closed end is pre-tensioned by the spring relative to the brake ramp and catch depression and is guided in the guide opening free of tilt.

13. The door-retaining rod of claim 12, wherein the door retaining rod further comprises a solid metal bushing encapsulated in an end of said door-retaining rod.

14. The door-retaining rod of claim 13, wherein the door retaining rod further comprises another solid metal bushing encapsulated in an opposite end of said door-retaining rod.

15. A doorstop comprising:
a retainer piece disposed on one of a door and a door support and including a plastic housing with a main opening and a guide opening arranged perpendicular to the main opening and parallel to a pivot axis of the door;
a door retaining rod comprising a serrated wire frame encapsulated in a link arm system, wherein the door retaining rod is articulated on the other end of the door and the door support, the door retaining rod passing through the main opening of the retainer piece housing and including a brake ramp and a catch depression on a side of the door retaining rod; and
a catch device configured to determine specific door opening positions and including a brake body and a spring, the catch device connecting the retainer piece and the door retaining rod to each other and in a moveable manner, wherein the brake body includes a hollow cylinder having a semi-spherical closed end and an open end and is slidingly disposed in the guide opening of the retainer piece, the open end partially accommodating the spring therein so that the closed end is pre-tensioned by the spring relative to the brake ramp and catch depression and is guided in the guide opening free of tilt.

16. A door-retaining rod comprising a molded arm of long strand material, wherein an external surface of the door-retaining rod is non-metallic.
